(19) United States
(12) Patent Application Publication
(10) Pub. No.: US 2015/0054951 A1
(43) Pub. Date: Feb. 26, 2015

(54) INFLUENCE OF LINE OF SIGHT FOR DRIVER SAFETY

(71) Applicant: EMPIRE TECHNOLOGY DEVELOPMENT, LLC, WILMINGTON, DE (US)

(72) Inventors: Benjamin Maytal, Mevassret (IL); Noam Meir, Herzlia (IL)

(73) Assignee: EMPIRE TECHNOLOGY DEVELOPMENT, LLC, WILMINGTON, DE (US)

(21) Appl. No.: 14/234,309

(22) PCT Filed: Aug. 22, 2013
(86) PCT No.: PCT/US13/56191

§ 371 Date: Jan. 22, 2014

(51) Int. Cl. G06K 9/00; G08B 21/04

(52) U.S. Cl. CPC G06K 9/00845; G08B 21/0476
USPC 348/148

(57) ABSTRACT

Technologies are generally described for systems and methods for influencing line of sight data. In some examples, a processor may determine a selection zone based on a location of a vehicle. The processor may select an object in the selection zone. The processor may generate an audio query that identifies the object. The processor may receive line of sight data that relates to a line of sight. The processor may determine whether the line of sight intersects the object based on the line of sight data. The processor may generate a response based on the determination.

### BACKGROUND

Unless otherwise indicated herein, the materials described in this section are not prior art to the claims in this application and are not admitted to be prior art by inclusion in this section.

Safe operation of a moving vehicle may require training, skill and a level of awareness to the vehicle's surroundings. A driver's attention level to the moving vehicle's surroundings may decrease during long drives, routine drives, or when unaccompanied.

### SUMMARY

According to some examples, methods for influencing line of sight data are generally described. The methods may include, by a processor, determining a selection zone based on a location of a vehicle. The methods may include selecting an object in the selection zone. The methods may further include generating an audio query that identifies the object. The methods may further include receiving line of sight data that relates to a line of sight. The methods may further include determining whether the line of sight intersects the object based on the line of sight data. The methods may further include generating a response based on the determination.

According to other examples, devices effective to influence line of sight data are generally described. The devices may include a memory that includes instructions. The devices may further include a processor configured to be in communication with the memory. The processor may be configured to determine a selection zone based on a location of a vehicle. The processor may be configured to select an object in the selection zone. The processor may be configured to generate an audio query that identifies the object. The processor may be configured to receive line of sight data that relates to a line of sight. The processor may be configured to determine whether the line of sight intersects the object based on the line of sight data. The processor may be configured to generate a response based on the determination.

According to further examples, systems effective to influence line of sight data are generally described. The systems may include a first device. The systems may include a second device configured to be in communication with the first device over a network. The first device may include a global positioning system (GPS) sensor effective to generate GPS data. The first device may include a speaker. The first device may include a line of sight sensor effective to generate line of sight data. The first device may include a first processor effective to receive the GPS data and the line of sight data, and to send the GPS data and line of sight data over the network to the second device. The second device may include a memory that includes instructions. The second device may include a second processor configured to be in communication with the memory. The second processor may be configured to receive the GPS data, determine a selection zone based on the GPS data and select an object in the selection zone. The second processor may be configured to generate an audio query to be sent over the network that identifies the object. The second processor may be configured to receive the line of sight data that relates to a line of sight and determine whether the line of sight intersects the object based on the line of sight data and the GPS data. The second processor may be configured to generate a response based on the determination.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example system that can be utilized to influence line of sight for driver safety;

FIG. 2 illustrates the example system of FIG. 1 with additional details pertaining to a selected visible object;

FIG. 3 illustrates the example system of FIG. 2 with additional details pertaining to a selected visible object;

FIG. 4 is a flow diagram illustrating an example process for implementing influence of line of sight for driver safety;

FIG. 5 illustrates a computer program product configured to influence line of sight for driver safety; and

FIG. 6 is a block diagram illustrating an example computing device that is arranged to influence line of sight for driver safety;

all arranged in accordance with at least some embodiments presented herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to technologies including methods, apparatus, systems, devices, and computer program products related to influencing of line of sight for driver safety.

Briefly stated, technologies are generally described for systems and methods for influencing line of sight data. In some examples, a processor may determine a selection zone based on a location of a vehicle. The processor may select an object in the selection zone. The processor may generate an audio query that identifies the object. The processor may receive line of sight data that relates to a line of sight and determine whether the line of sight intersects the object based on the line of sight data. The processor may generate a response based on the determination.

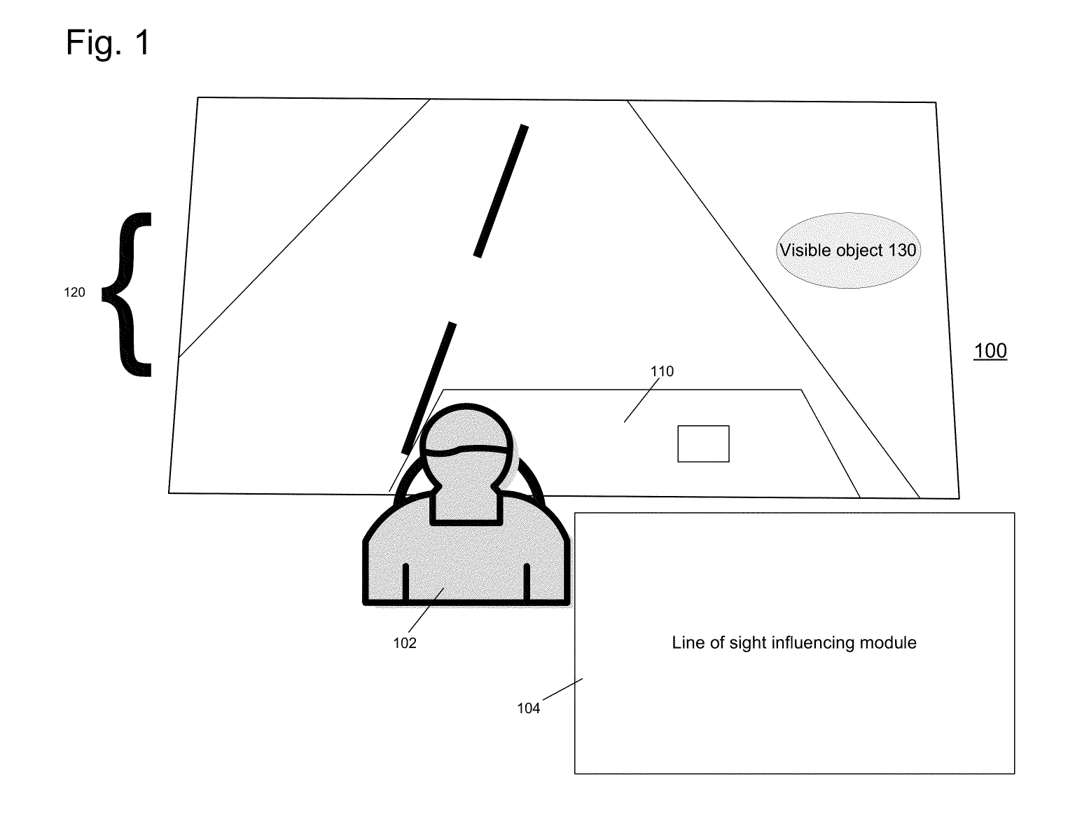

FIG. 1 illustrates an example system 100 that can be utilized to influence a line of sight for driver safety, arranged in accordance with at least some embodiments presented herein. As depicted, system 100 may include a light of sight influencing module 104.

As discussed in more detail below, line of sight influencing module 104 may select a visible object 130 in a selection zone 120. Line of sight influencing module 104 may generate an audio query output to driver 102 identifying visible object 130 to be detected. A driver 102, driving a vehicle 110, may scan selection zone 120 to attempt to detect visible object 130. Line of sight influencing module 104 may determine a line of sight for driver 102 and determine if the line of sight intersects visible object 130. Line of sight influencing module 104 may determine that driver 102 has detected visible object 130 when line of sight of driver 102 intersects visible object 130 within a threshold amount of time. Line of sight influencing module 104 may determine driver 102 has not detected visible object 130 when line of sight of driver 102 does not intersect visible object 130 within the threshold amount of time.

In response to determining driver 102 has detected visible object 130, line of sight influencing module 104 may generate a response. The response may be an audio response. Line of sight influencing module 104 may also generate a score when line of sight of driver 102 intersects visible object 130 within the threshold amount of time. Line of sight influencing module 104 may thereafter select a new visible object in selection zone 120 for driver 102 to detect.

In response to determining driver 102 has not detected visible object 130 within the threshold amount of time, line of sight influencing module 104 may generate an audio alarm. Line of sight influencing module 104 may thereafter select a new visible object in selection zone 120 for driver 102 to detect.

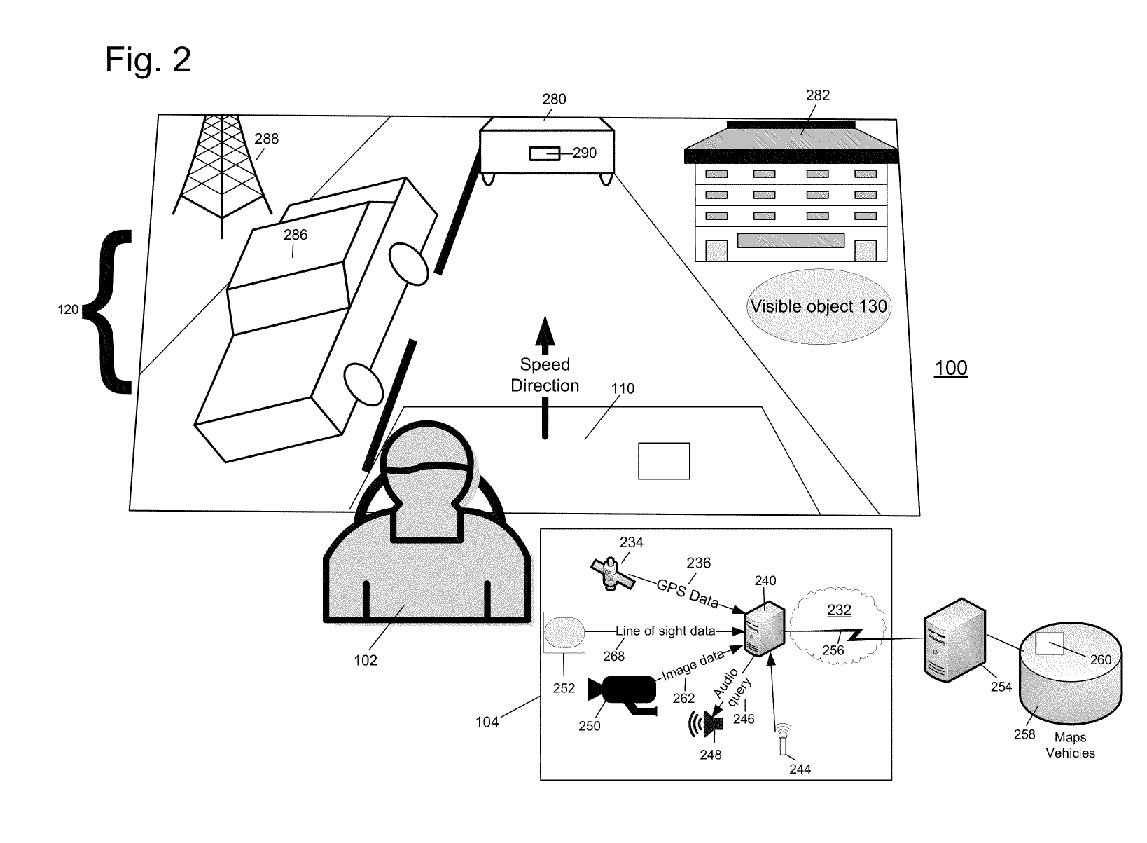

FIG. 2 illustrates the example system 100 of FIG. 1 with additional details pertaining to a selected visible object, arranged in accordance with at least some embodiments presented herein. Those components in FIG. 2 that are labeled identically to components of FIG. 1 will not be described again for the purposes of clarity.

As depicted, system 100 may include a global positioning (GPS) device 234, an eye tracking and motion sensor 252, a camera 250, a microphone 244, a speaker 248, and a processor 240. At least some of the elements of system 100 may be arranged to be in communication with a processor 254 outside of a vehicle 110 through a communication link 256. Processor 254 may be in communication with processor 240 and components of line of sight influencing module 104 in vehicle 110 across a network 232. In some examples, processor 254 may be adapted to be in communication with a memory 258 that may include instructions 260 stored therein. Processor 254 may be configured, such as by instructions 260 to control at least some of the operations/actions/functions described below.

In an example, driver 102 may be operating vehicle 110. Driver 102 may submit a request, for example, through speaking into microphone 244, to start implementation of instructions 260. Processor 254 may receive the request. Processor 254 may receive global positioning (GPS) data 236 from GPS device 234. Processor 254 may analyze GPS data 236 and determine a location, speed and direction of vehicle 110. Processor 254 may, by executing instructions 260, use GPS data 236 with memory 258 to select visible object 130 identified in memory 258 that may be in selection zone 120. Selection zone 120 may be an area in front of vehicle 110 determined by processor 254 from GPS data 236. For example, selection zone 120 may include an area that vehicle 110 may encounter within about 3 to about 15 seconds based on the current speed and direction of vehicle 110. Examples of a visible object that may be selected by processor 254 from GPS data 236 and memory 258 may be a church tower, a McDONALDS restaurant, a gas station, a water tower, etc. As shown in FIG. 2, further examples may be a tower 288, an oncoming vehicle 286, a vehicle in front of the operated vehicle 280, a license plate 290, or a building 282. Memory 258 may include a database of maps, including locations of objects, and a database including identification and location of other vehicles operating system 100.

Instructions 260 may provide processor 254 with rules to analyze GPS data 236 and memory 258 to select visible object 130 and subsequent visible objects for detection by driver 102. Processor 254 may, by executing instructions 260, select a particular visible object 130 based on the location of the particular visible object 130 within selection zone 120 so as to influence the line of sight of driver 102 and influence line of sight data 268. Subsequent visible objects may be selected based on their locations in selection zone 120 to further influence the line of sight of driver 102.

For example, looking at FIG. 2, a first visible object to be detected by driver 102 may be selected to be oncoming vehicle 286, influencing the line of sight of driver 102 to the left and approximately twenty feet in front of vehicle 110. Processor 254 may then select building 282 as a subsequent visible object to be detected by driver 102, influencing the line of sight of driver 102 to the right and approximately seventy feet ahead of vehicle 110. Processor 254, by executing instructions 260, may continually influence the line of sight of driver 102, and consequently line of sight data 268, by selecting visible objects that are located at different directions and depths within selection zone 120.

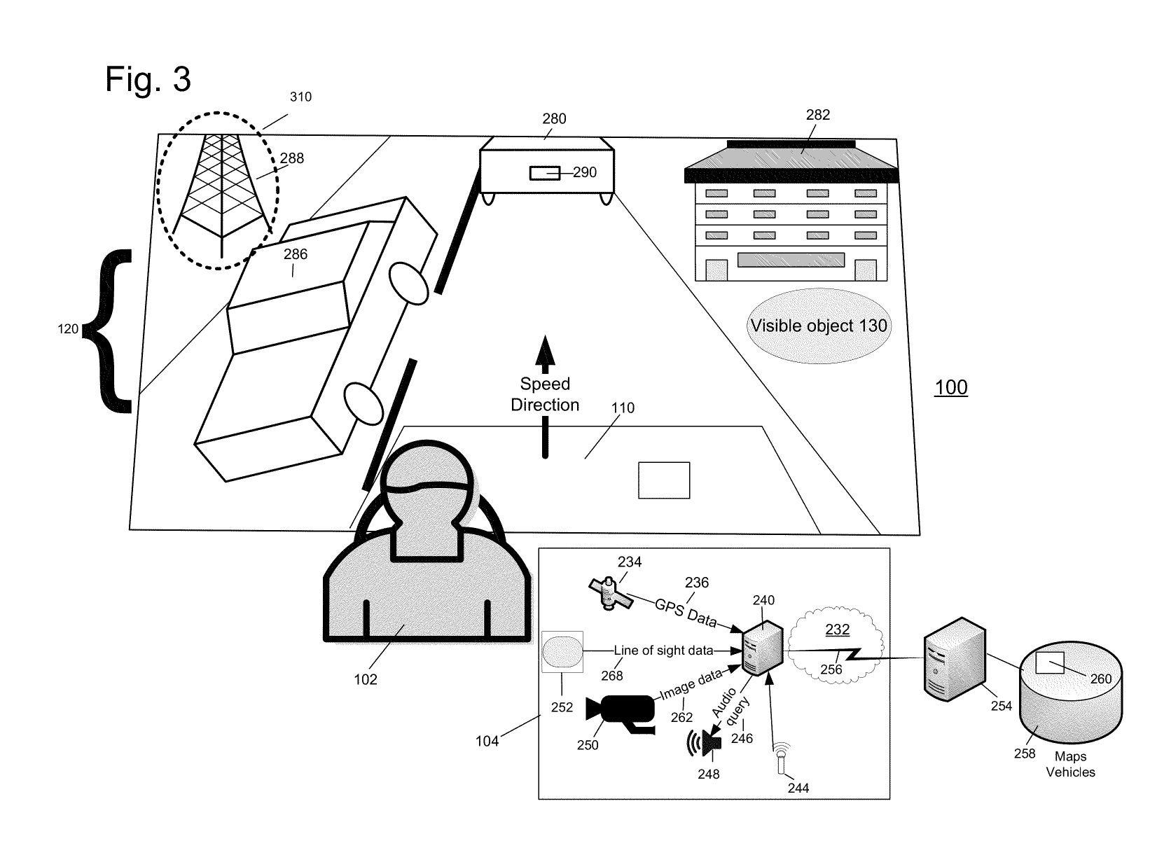

FIG. 3 illustrates the example system of FIG. 2 with additional details pertaining to a selected visible object, arranged in accordance with at least some embodiments presented herein. Those components in FIG. 3 that are labeled identically to components of FIGS. 1 and 2 will not be described again for the purposes of clarity.

In an example, processor 254 may select a selected object 310—as illustrated by tower 288 being highlighted with a circle. Upon selecting selected object 310, processor 254 may, by executing instructions 260, generate and send an audio query 246 to driver 102 through speaker 248. Audio query 246 may identify selected object 310 to be detected by driver 102 to influence a line of sight of driver 102. Driver 102 may scan selection zone 120 in an attempt to detect selected object 310 generating line of sight data 268. Eye tracking and motion sensor 252 may detect driver 102 pupil location and head rotation when camera 250 is attached to vehicle 110. Eye tracking and motion sensor 252 may detect driver 102 pupil location when camera 250 is located in glasses worn by driver 102. Eye tracking and motion sensor 252 may not detect driver 102 head position when camera 250 is located in glasses worn by driver 102. Eye tracking and motion sensor 252 may generate and send line of sight data 268 to processor 254. Line of sight data 268 may relate to a line of sight for driver 102. A line of sight may include, for example, a location of the pupils of driver 102 and a spatial angle at which driver 102 is looking Eye tracking and motion sensor 252 may take into account eye movement and head rotation based on the motion sensor when generating line of sight data 268. For example, eye tracking and motion sensor 252 may determine a location of the pupils of driver 102. Eye tracking and motion sensor may be part of a glasses eye tracking device or a separate device which may image driver 102 eyes and head, to generate pupil location and head angle data for line of sight data 268.

Processor 254 may, by executing instructions 260, analyze line of sight data 268 and memory 258 to determine if line of sight of driver 102 intersects selected object 310. Upon determination that line of sight of driver 102 has intersected selected object 310, processor 254 may determine that selected object 310 was detected by driver 102. Processor 254 may send an audio acknowledgement of a successful detection by driver 102 through speaker 248.

Processor 254 may generate a score for driver 102 for the successful detection and thereafter select a new visible object to be detected. A score may vary and a value of the score may be based on a difficulty level of the object to detect. For example, a red car may be easier to detect than a gray car and may result in generation of a lower score. In another example, a church may be easier to detect than a mail box and may result in generation of a lower score.

Processor 254 may determine that driver 102 did not detect selected object 310 when line of sight of driver 102 does not intersect with selected object 130 within a threshold period of time, for example between about 1 to about 4 seconds. Processor 254 may generate an audio alarm as an indication of an unsuccessful detection through speaker 248. Processor 254 may require driver 102 to acknowledge the audio alarm. Acknowledgement may be a head movement or an audio response. Processor 254 may send a second audio alarm, louder than the first audio alarm, if the first audio alarm is not acknowledged. In response to receiving an acknowledgement from driver 102, processor 254 may select a new visible object in selection zone 120 for driver 102 to detect.

In another example, processor 254 may receive image data 262 from camera 250. Camera 250 may be attached to vehicle 110 and directed toward selection zone 120. Camera 250 may be part of eye tracking glasses worn by driver 102. Image data 262 may include images of objects in selection zone 120. Processor 254 may, by executing instructions 260, analyze line of sight data 268, image data 262, and GPS data 236 to determine if line of sight of driver 102 intersects selected object 310. For example, processor 254 may perform image processing on image data 262 based on line of sight data 268 to determine whether line of sight of driver 102 intersects selected object 310. In an example when camera 250 is part of eye tracking glasses worn by driver 102, processor 254 may detect a point that driver 102 is looking at by using image data 262 and line of sight data 268 where line of sight data 268 includes the angle of the line of sight. In an example when camera 250 is attached to vehicle 110, processor 254 may detect the point that driver 102 is looking at by using image data 262 and line of sight data 268, where line of sight data 268 includes the angle of the line of sight and includes head motion data.

Processor 254 may analyze image data 262 and identify traffic conditions. Processor may stop generating audio query 246 based on the traffic conditions. Traffic conditions that may merit stopping generation of audio query 246 may include an accident, construction, heavy traffic, emergency vehicle lights, etc. Upon identifying traffic conditions, processor 254 may indicate to driver 102 that generation of audio query 246 has been stopped due to a pending traffic condition. In another example, generation of audio query 246 may occur when vehicle 110 is operating under cruise control.

In an example, influence of line of sight for driver safety may be implemented in the form of an interactive game. Processor 254 may select an object 310 to be detected by driver 102 and may generate audio query 246 to identify selected object 310. Processor 254 may determine successful or unsuccessful detection of selected object 310 by driver 102 and produce a score for driver 102. A score may vary and a value of the score may be based on a difficulty level of the object to detect as well as an amount of time between audio query 246 and a successful detection. Processor 254 may tally scores from multiple successful and/or unsuccessful detections by driver 102 to generate a game score.

Among other possible benefits, influencing of line of sight may increase driver 102 awareness of the surroundings of vehicle 110 due to driver 102 scanning selection zone 120. Scanning may decrease the chance that driver 102 may miss valuable visual information for the safe operation of vehicle 102. Continual scanning and the challenge of detecting objects may prevent driver 102 from fatigue due from the monotony inherent with driving distances. Continual queries may prevent driver 102 boredom and keep driver 102 focused and the driver need not take his or her eyes off of the road.

A system in accordance with the present disclosure may also aid driver safety by generating an alarm when driver 102 is unable to detect selected object 130. Alarms may refocus driver 102, or may indicate to driver 102 that driver 102 is not attentive and should rest. Alarms may aid driver safety and occur prior to driver 102 encountering a dangerous situation.

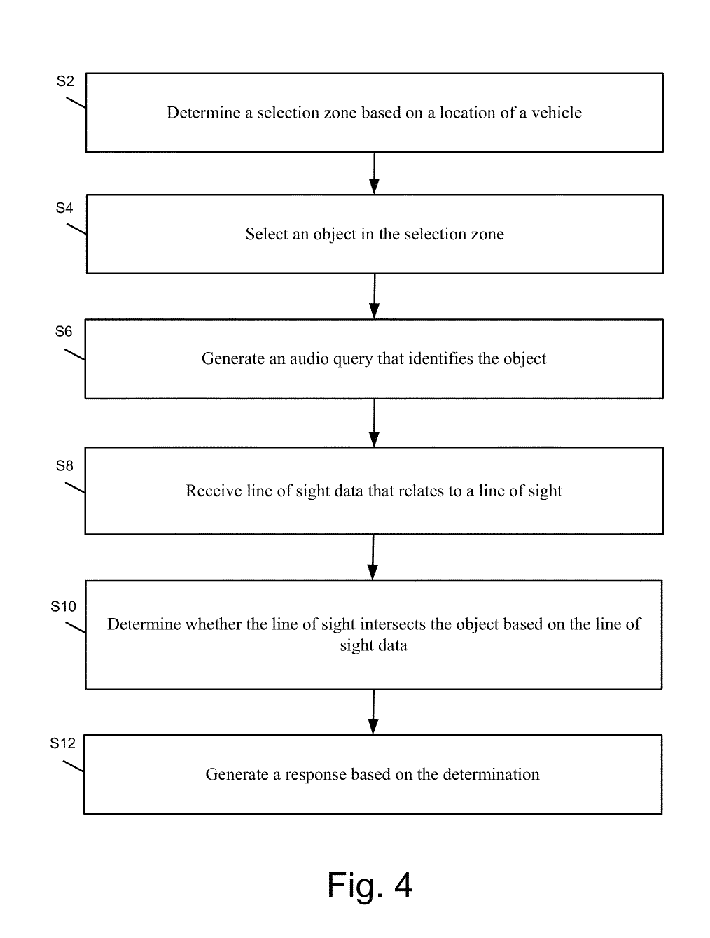

FIG. 4 is a flow diagram illustrating an example process for implementing influence of line of sight for driver safety, arranged in accordance with at least some embodiments presented herein. The process in FIG. 4 could be implemented using, for example, system 100 discussed above. The example process may include one or more operations, actions, or functions as illustrated by one or more of blocks S2, S4, S6, S8, S10 and/or S12. Although illustrated as discrete blocks, various blocks may be divided into additional blocks, combined into fewer blocks, or eliminated, depending on the desired implementation.

Processing may begin at block S2 “Determine a selection zone based on a location of a vehicle.” At block S2, a processor may determine a selection zone based on the location of a vehicle. The processor may receive GPS data from a GPS sensor in the vehicle. The processor may determine the selection zone based on a speed and/or direction of the vehicle. The processor may be inside or outside of the vehicle.

Processing may continue from block S2 to block S4 “Select an object in the selection zone.” At block S4, the processor may determine objects within the selection zone. The processor may use the GPS data and objects in memory to determine objects in the selection zone. In some examples, the object may be a church tower, a McDONALDS restaurant, a gas station, a water tower, etc.

Processing may continue from block S4 to block S6 “Generate an audio query that identifies the object.” At block S6, the processor may generate an audio query that identifies the object. The audio query may be output through a speaker.

Processing may continue from block S6 to block S8 “Receive line of sight data that relates to a line of sight.” At block S8, the processor may receive line of sight data that relates to a line of sight of a driver. The line of sight data may be generated by an eye tracking and motion sensor. The eye tracking and motion sensor may take into account eye movement, line of sight angle, and head motion.

Processing may continue from block S8 to block S10 “Determine whether the line of sight intersects the object based on the line of sight data.” At block S10, the processor may determine whether the line of sight intersects the object based on the line of sight data. The processor may analyze the line of sight data and the location of the object in memory to determine if the line of sight intersects the selected object. Upon determination that the line of sight has intersected the selected object, the processor may determine that the selected object was detected by the driver.

In another example, the processor may determine that the driver did not detect the selected object if the line of sight does not intersect with the selected object within a threshold period of time.

Processing may continue from block S10 to block S12 “Generate a response based on the determination.” At block S12, the processor may generate a response based on the determination. The determination may be that the selected object was detected by the driver and the processor may respond with an audio response. The determination may be that the selected object was not detected by the driver and the processor may respond with an alarm. The processor may generate an alarm to prevent driver inattention and increase safety.

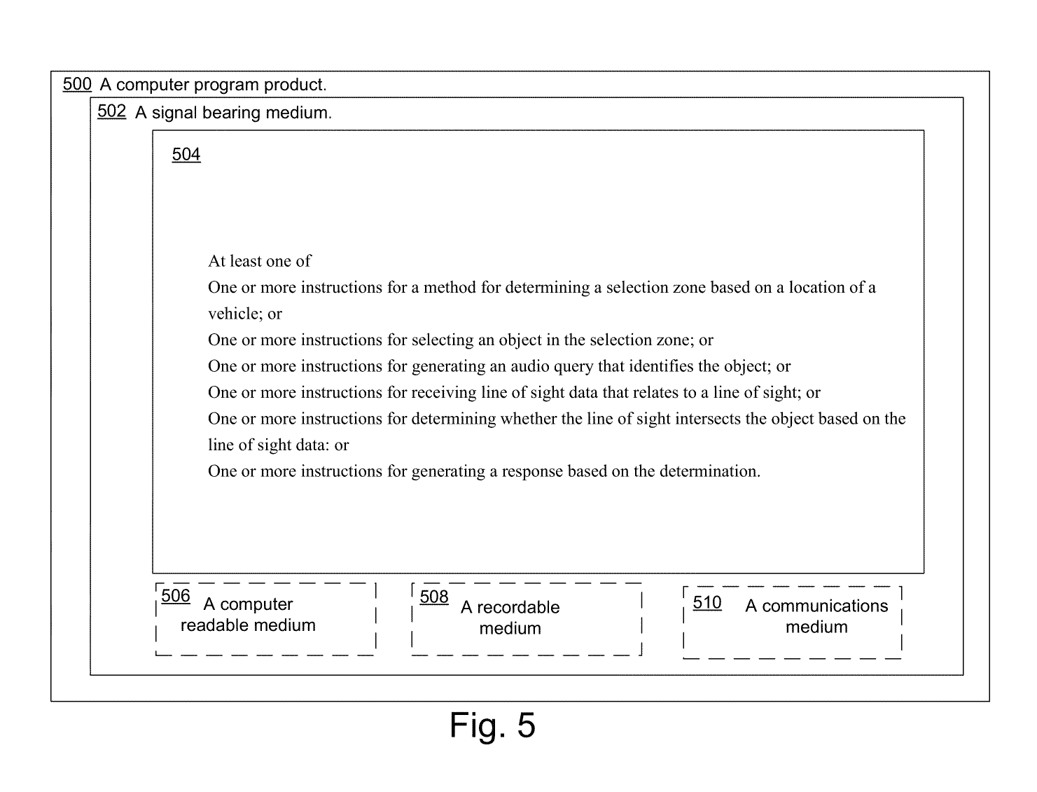

FIG. 5 illustrates a computer program product 500 configured to influence a line of sight for driver safety, arranged in accordance with at least some embodiments presented herein. Program product 500 may include a signal bearing medium 502. Signal bearing medium 502 may include one or more instructions 504 that, when executed by, for example, a processor, may provide the functionality described above with respect to FIGS. 1-4. Thus, for example, referring to system 100, processor 254 or processor 240 may undertake one or more of the blocks shown in FIG. 5 in response to instructions 504 conveyed to system 100 by medium 502.

In some implementations, signal bearing medium 502 may encompass a computer-readable medium 506, such as, but not limited to, a hard disk drive, a Compact Disc (CD), a Digital Video Disk (DVD), a digital tape, memory, etc. In some implementations, signal bearing medium 502 may encompass a recordable medium 508, such as, but not limited to, memory, read/write (R/W) CDs, R/W DVDs, etc. In some implementations, signal bearing medium 502 may encompass a communications medium 510, such as, but not limited to, a digital and/or an analog communication medium (e.g., a fiber optic cable, a waveguide, a wired communications link, a wireless communication link, etc.). Thus, for example, program product 500 may be conveyed to one or more modules of the systems 100 or 200 by an RF signal bearing medium 502, where the signal bearing medium 502 is conveyed by a wireless communications medium 510 (e.g., a wireless communications medium conforming with the IEEE 802.11 standard).

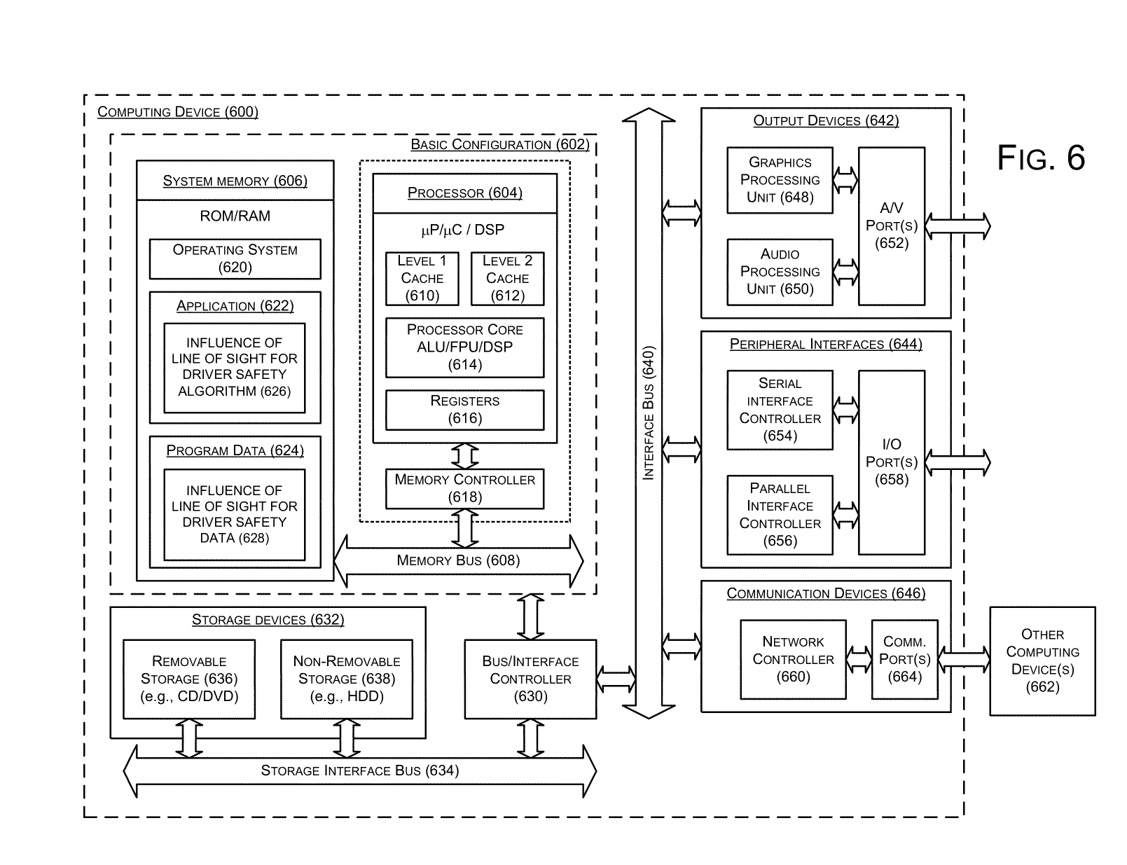

FIG. 6 is a block diagram illustrating an example computing device 600 that is arranged to influence of line of sight for driver safety arranged in accordance with at least some embodiments presented herein. In a very basic configuration 602, computing device 600 typically includes one or more processors 604 and a system memory 606. A memory bus 608 may be used for communicating between processor 604 and system memory 606.

Depending on the desired configuration, processor 604 may be of any type including but not limited to a microprocessor (μP), a microcontroller (μC), a digital signal processor (DSP), or any combination thereof. Processor 604 may include one more levels of caching, such as a level one cache 610 and a level two cache 612, a processor core 614, and registers 616. An example processor core 614 may include an arithmetic logic unit (ALU), a floating point unit (FPU), a digital signal processing core (DSP Core), or any combination thereof. An example memory controller 618 may also be used with processor 604, or in some implementations memory controller 618 may be an internal part of processor 604.

Depending on the desired configuration, system memory 606 may be of any type including but not limited to volatile memory (such as RAM), non-volatile memory (such as ROM, flash memory, etc.) or any combination thereof. System memory 606 may include an operating system 620, one or more applications 622, and program data 624.

Application 622 may include an influence of line of sight for driver safety algorithm 626 that is arranged to perform the functions as described herein including those described previously with respect to FIGS. 1-5. Program data 624 may include influence of line of sight for driver safety data 628 that may be useful for influence of line of sight for driver safety as is described herein. In some embodiments, application 622 may be arranged to operate with program data 624 on operating system 620 such that influence of line of sight for driver safety may be provided. This described basic configuration 602 is illustrated in FIG. 6 by those components within the inner dashed line.

Computing device 600 may have additional features or functionality, and additional interfaces to facilitate communications between basic configuration 602 and any required devices and interfaces. For example, a bus/interface controller 630 may be used to facilitate communications between basic configuration 602 and one or more data storage devices 632 via a storage interface bus 634. Data storage devices 632 may be removable storage devices 636, non-removable storage devices 638, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 606, removable storage devices 636 and non-removable storage devices 638 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

Computing device 600 may also include an interface bus 640 for facilitating communication from various interface devices (e.g., output devices 642, peripheral interfaces 644, and communication devices 646) to basic configuration 602 via bus/interface controller 630. Example output devices 642 include a graphics processing unit 648 and an audio processing unit 650, which may be configured to communicate to various external devices such as a display or speakers via one or more A/V ports 652. Example peripheral interfaces 644 include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link via one or more communication ports 664.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 600 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for influencing line of sight data, the method comprising by a processor:
determining a selection zone based on a location of a vehicle;
selecting an object in the selection zone;
generating an audio query that identifies the object;
subsequent to generating the audio query, receiving line of sight data that relates to a line of sight;
determining whether the line of sight intersects the object based on the line of sight data; and
generating a response based on the determination.

2. The method of claim 1, wherein the processor is outside of the vehicle and configured be in communication with the vehicle over a network.

3. The method of claim 1, further comprising the processor:
receiving global positioning system (GPS) data for the vehicle from a GPS sensor; and
determining the selection zone from the GPS data.

4. The method of claim 3, further comprising the processor:
determining a speed of the vehicle;
determining a direction of the vehicle; and
determining the selection zone based on the speed and direction.

5. The method of claim 3, further comprising;
receiving image data from a camera, wherein the image data relates to the selection zone; and
determining whether the line of sight intersects the object includes processing the image data, the line of sight data and the GPS data.

6. The method of claim 1, wherein the processor is configured to be in communication with a memory, wherein the memory includes locations of objects and locations of other vehicles; and
selecting the object includes analyzing the memory.

7. The method of claim 1, further comprising:
determining that the line of sight intersects the object within a threshold amount of time; and
generating an audio response to be sent through a speaker in response to the determination that the line of sight intersects the object within the threshold amount of time.

8. The method of claim 1, further comprising:
determining that the line of sight does not intersect the object within a threshold amount of time; and
generating an alarm in response to the determination that the line of sight does not intersect the object within the threshold amount of time.

9. The method of claim 8, further comprising generating an audio alarm to be sent through a speaker in response to the determination that the line of sight does not intersect the object within the threshold amount of time.

10. The method of claim 1, further comprising;
receiving image data from a camera, wherein the image data relates to the selection zone;
identifying a traffic condition in the selection zone; and
stopping generation of the audio query based on the traffic condition.

11. A device effective to influence line of sight data, the device comprising
a memory that includes instructions; and
a processor configured to be in communication with the memory, the processor configured to:
determine a selection zone based on a location of a vehicle;
select an object in the selection zone;
generate an audio query that identifies the object;
subsequent to generation of the audio query, receive line of sight data that relates to a line of sight;
determine whether the line of sight intersects the object based on the line of sight data; and
generate a response based on the determination.

12. The device of claim 11, wherein the processor is outside of the vehicle and configured be in communication with the vehicle over a network.

13. The device of claim 11, wherein the processor is further configured to:
receive global positioning (GPS) data for the vehicle from a GPS sensor; and
determine the selection zone from the GPS data.

14. The device of claim 13, wherein the processor is further configured to:
determine a speed of the vehicle;
determine a direction of the vehicle; and
determine the selection zone based on the speed and direction.

15. The device of claim 13, wherein the processor is further configured to:
receive image data from a camera, wherein the image data relates to the selection zone; and
the determination of whether the line of sight intersects the object is based on the image data, the line of sight data and the GPS data.

16. The device of claim 11, wherein the memory further includes locations of objects and locations of other vehicles; and
wherein the processor is further configured to select the object based on analysis of the memory.

17. The device of claim 13, wherein the processor is further configured to:
determine that the line of sight intersects the object within a threshold amount of time; and
generate an audio response to be sent through a speaker in response to the determination that the line of sight intersects the object within the threshold amount of time.

18. A system effective to influence line of sight data, the system comprising:
a first device; and
a second device configured to be in communication with the first device over a network;
where the first device includes
a global positioning system (GPS) sensor effective to generate GPS data;
a line of sight sensor effective to generate line of sight data; and
a first processor effective to receive the GPS data and the line of sight data, and to send the GPS data and line of sight data over the network to the second device;
the second device includes:
a memory that includes instructions; and
a second processor configured to be in communication with the memory and the second processor is configured to:
receive the GPS data;
determine a selection zone based on the GPS data;
select an object in the selection zone;
generate an audio query to be sent over the network that identifies the object;
subsequent to generation of the audio query, receive the line of sight data that relates to a line of sight;
determine whether the line of sight intersects the object based on the line of sight data and the GPS data; and
generate a response based on the determination.

19. The system of claim 18, wherein the first device further includes:
a camera effective to generate image data; and wherein:
the first processor is effective to receive and send the image data over the network to the second device; and
the second device is effective to determine whether the line of sight intersects the object based on the image data, the line of sight data and the GPS data.

20. The system of claim 18, wherein the second processor is effective to:
determine a speed of the vehicle;
determine a direction of the vehicle; and
determine the selection zone based on the speed and direction.
